(19) United States
(12) Patent Application Publication
(10) Pub. No.: US 2002/0006549 A1
(43) Pub. Date: Jan. 17, 2002

(54) Preparation of a mixed metal oxide cathode active material by sequential decomposition and combination reactions

(76) Inventors: Randolph A. Leising, Williamsville, NY (US); Esther S. Takeuchi, East Amherst, NY (US)

Correspondence Address: Michael F. Scalise, Hodgson, Russ, Andrews, Woods & Goodyear LLP, One M&T Plaza, Suite 2000, Buffalo, NY, 14203-2391, US

(21) Appl. No.: 09/746,787

(22) Filed: Mar. 12, 2001

Related U.S. Application Data
(60) Provisional application No. 60/173,407, filed on Dec. 28, 1999.

(51) Int. Cl. H01M 4/48; H01M 4/54; H01M 10/40

(52) U.S. Cl. 429/218.1; 429/324; 429/219; 429/231.5; 429/337; 429/338; 429/339; 429/340; 429/330

(57) ABSTRACT

A mixed metal oxide, such as silver vanadium oxide, prepared by sequential decomposition and combination reactions is described. In the case of silver vanadium oxide, the product material is produced from a decomposable salt of silver and vanadium oxide first heated above the decomposition temperature of the silver salt followed by cooling and then a second heating above the decomposition temperature. The product silver vanadium oxide material is coupled with a lithium anode and activated with a nonaqueous electrolyte to provide an improved high energy density electrochemical cell having increased pulse voltages and a reduction in voltage delay.

### CROSS-REFERENCE TO RELATED APPLICATION

The present invention claims priority based on provisional application Ser. No. 60/173,407, filed Dec. 28, 1999.

### BACKGROUND OF THE INVENTION

1. Field of the Invention

The present invention generally relates to the conversion of chemical energy to electrical energy, and more particularly, to an alkali metal electrochemical cell having a mixed metal oxide cathode activated with a nonaqueous electrolyte. The mixed metal oxide of the cathode is preferably silver vanadium oxide produced in a decomposition reaction followed by a combination reaction.

2. Prior Art

U.S. Pat. Nos. 4,310,609 and 4,391,729, both to Liang et al., disclose the preparation of silver vanadium oxide (SVO) as a cathode active material for use in a nonaqueous electrolyte battery. These patents describe the preparation of silver vanadium oxide by a thermal decomposition reaction involving a final heat treatment step of about 360° C.

U.S. Pat. No. 4,830,940 to Keister et al. describes a solid cathode, liquid organic electrolyte, lithium cell for delivering high current pulses. The solid cathode includes as an active material AgₓV₂O_{y} wherein x is in the range from about 0.5 to about 2.0 and y is in the range from about 4.5 to 6.0. Keister et al. reference the publication “Effect of Silver Content On the Performance of Primary Lithium/Silver Vanadium Oxide Batteries”, Takeuchi et al., Electrochemical Society, Oct. 13-18, 1985, Las Vegas, Nev., Abstract No. 125, which describes the preparation of silver vanadium oxide at about 360° C. from the thermal decomposition of silver nitrate and vanadium pentoxide.

In the publications of Leising et al., Chemistry of Materials, 5, 738-742 (1993) and Leising et al., Chemistry of Materials, 6, 489-495 (1994) the preparation of silver vanadium oxide by the thermal decomposition of AgNO₃ and V₂O₅ is described.

U.S. Pat. No. 5,498,494 to Takeuchi et al., which is assigned to the assignee of the present invention and incorporated herein by reference, describes the preparation of SVO from Ag₂O and V₂O₅ by a chemical addition reaction. U.S. Pat. No. 5,221,453 to Crespi also discloses the preparation of silver vanadium oxide by a chemical addition reaction (combination of AgVO₃ and V₂O₅ or Ag₂O and V₂O₅) in a temperature range of about 300° C. to about 700° C. The preparation of SVO from silver oxide and vanadium oxide also has been well documented in the literature. In the publications: Fleury, P.; Kohlmuller, R. C. R. Acad. Sci. Paris 1966, 262C, 475-477 and Casalot, A.; Pouchard, M. Bull. Soc. Chim. Fr. 1967, 3817-3820 the reaction of silver oxide with vanadium oxide is described, and in Wenda, E. J. Thermal Anal. 1985, 30, 879-887, the phase diagram of the V₂O₅-Ag₂O system is presented where these materials were heated under oxygen to form SVO and other silver vanadium oxide bronze materials.

In that respect, a chemical addition reaction is described as being distinct from a thermal decomposition reaction. A decomposition reaction is characterized by the evolution of nitrogen oxide gas when the reactants are V₂O₅ and AgNO₃. A chemical addition reaction does not include the evolution of reaction by-product gases.

### SUMMARY OF THE INVENTION

The present invention relates to a nonaqueous electrolyte, alkali metal/mixed metal oxide electrochemical cell and, in particular, a lithium/silver vanadium oxide electrochemical cell designed for high current pulse discharge applications while exhibiting reduced or no appreciable voltage delay. An example of such an application is an implantable cardiac defibrillator, where the battery may run under a light load, device monitoring mode for extended periods of time interrupted by high rate, current pulse discharge during device activation. Voltage delay is a phenomenon typically exhibited in a lithium/silver vanadium oxide cell that has been depleted of about 40% to about 70% of its capacity and is subjected to current pulse discharge applications. The occurrence of voltage delay is detrimental because it may result in delayed device activation and shortened device life.

The desirable decrease in voltage delay is realized in lithium cells that, according to the present invention, contain a mixed metal oxide such as silver vanadium oxide prepared in sequential decomposition and combination reactions, and are activated with a nonaqueous electrolyte. A particularly preferred mixed metal oxide cathode active material produced in this manner comprises silver vanadium oxide having the general formula AgₓV₂O_{y} wherein in the ε-phase x=1.0 and y=5.5. According to the present invention, this material is produced in a decomposition reaction of a first salt of silver and a second metal oxide by first heating the mixture of starting materials to a temperature above the decomposition temperature of at least one of the two or more reactants. After cooling and grinding the mixture, it is subjected to a second heating during which the combination of starting materials react chemically. A typically used electrolyte for activating the Li/SVO electrochemical couple comprises 1M LiAsF₆ dissolved in a 50:50 mixture, by volume, of PC and DME.

These and other aspects of the present invention will become increasingly more apparent to those skilled in the art by reference to the following description and to the appended drawings.

### BRIEF DESCRIPTION OF THE DRAWINGS

FIG. 1 is the Differential Thermal Analysis (DTA) curve of a decomposition reaction of AgNO₃ and V₂O according to the prior art.

FIG. 2 is the DTA curve of a combination reaction of ½Ag₂O and V₂O₅ according to the prior art.

FIG. 3 is the DTA curve of the sequential decomposition and combination reactions of ½Ag₂CO₃ and V₂O₅ according to the present invention.

FIGS. 4 and 5 are the SEM micrographs at 100× and 1,000×, respectively, of SVO produced by a decomposition reaction according to the prior art.

FIGS. 6 and 7 are the SEM micrographs at 100× and 1,000×, respectively, of SVO produced by a combination reaction according to the prior art.

FIGS. 8 and 9 are the SEM micrographs at 100× and 1,000×, respectively, of SVO produced by sequential decomposition and combination reactions according to the present invention.

FIGS. 10 and 11 are graphs of the average pulse 1 minima and pulse 4 minima values, respectively, at 55% depth of discharge for Li/SVO cells containing DS-SVO in comparison to D-SVO.

### DETAILED DESCRIPTION OF THE PREFERRED EMBODIMENTS

The term “decomposition reaction” means a reaction producing a material, such as silver vanadium oxide, by the decomposition of at least one of two or more reactants during a chemical synthesis. The decomposition liberates a gaseous byproduct which is not incorporated into the product material.

The term “combination reaction” means a reaction producing a material, such as silver vanadium oxide, by the combination of starting materials which react chemically, but do not evolve any gaseous byproducts during the reaction.

The term “sequential decomposition and combination reactions” means a first reaction producing a material, such as silver vanadium oxide, by the decomposition of at least one of two or more reactants during a chemical synthesis. This decomposition reaction produces a gaseous byproduct which is not incorporated into the final product material. The products of the decomposition reaction are subsequently chemically reacted via a combination reaction to produce the product material, such as the product silver vanadium oxide.

In the prior art, SVO prepared by a decomposition reaction has been termed D-SVO, while SVO prepared by a combination reaction has been called C-SVO. For SVO prepared by the sequential decomposition and combination reactions of the present invention, the resultant material is referred to as DC-SVO.

As used herein, the term “pulse” means a short burst of electrical current of a greater amplitude than that of a prepulse current immediately prior to the pulse. A pulse train consists of at least two pulses of electrical current delivered in relatively short succession with or without open circuit rest between the pulses.

Lower pulse voltages caused by voltage delay, even if only temporary, are undesirable since they can cause circuit failure in device applications, and effectively result in shorter cell life. As is well known by those skilled in the art, an implantable cardiac defibrillator is a device that requires a power source for a generally medium rate, constant resistance load component provided by circuits performing such functions as, for example, the heart sensing and pacing functions. From time to time, the cardiac defibrillator may require a generally high rate, pulse discharge load component that occurs, for example, during charging of a capacitor in the defibrillator for the purpose of delivering an electrical shock to the heart to treat tachyarrhythmias, the irregular, rapid heartbeats that can be fatal if left uncorrected. Accordingly, reduction and even elimination of voltage delay during a current pulse application is important for proper device operation and extended device life.

The electrochemical cell of the present invention is particularly suited for powering an implantable medical device such as a cardiac defibrillator and the like. The cell comprises an anode of a metal selected from Groups IA, IIA and IIIB of the Periodic Table of the Elements, including lithium, sodium, potassium, etc., and their alloys and intermetallic compounds including, for example, Li—Si, Li—Al, Li—B and Li—Si—B alloys and intermetallic compounds. The preferred anode comprises lithium. An alternate anode comprises a lithium alloy, such as lithium-aluminum alloy. The greater the amount of aluminum present by weight in the alloy, however, the lower the energy density of the cell.

The form of the anode may vary, but preferably the anode is a thin metal sheet or foil of the anode metal, pressed or rolled on a metallic anode current collector, i.e., preferably comprising nickel, to form an anode component. In the exemplary cell of the present invention, the anode component has an extended tab or lead of the same material as the anode current collector, i.e., preferably nickel, integrally formed therewith such as by welding and contacted by a weld to a cell case of conductive material in a case-negative electrical configuration. Alternatively, the anode may be formed in some other geometry, such as a bobbin shape, cylinder or pellet to allow an alternate low surface cell design.

The electrochemical reaction at the cathode involves conversion of ions which migrate from the anode to the cathode into atomic or molecular forms. A preferred cathode active material of the present invention comprises a mixed metal oxide, such as silver vanadium oxide, prepared by sequential decomposition and combination reactions. By way of example, the thermal reaction of silver nitrate with vanadium oxide is a typical decomposition preparation of silver vanadium oxide cathode active material. This decomposition reaction is illustrated below in equation 1.

AgNO₃+V₂O₅→AgV₂O_{5.5}+NOₓ (1)

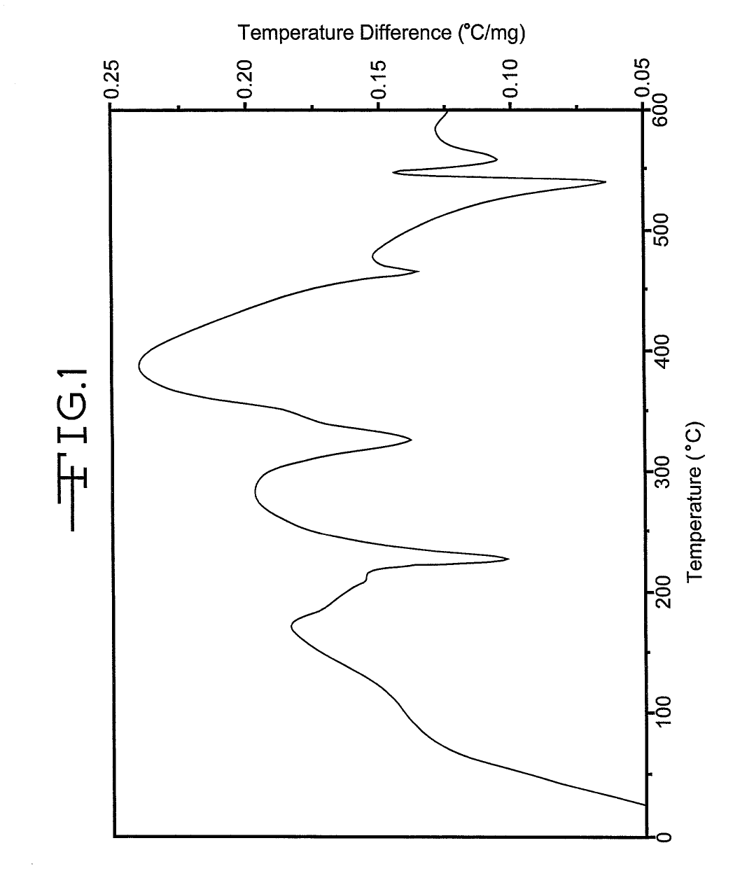

The thermal analysis of this reaction mixture is shown in FIG. 1. In this figure, the broad endothermic transition centered at about 328° C. is assigned to the decomposition of silver nitrate in the presence of vanadium oxide. During the decomposition of silver nitrate, toxic NOₓ gas is released. At temperatures above 328° C., only the isotherms corresponding to the product silver vanadium oxide phases are seen, indicating that the decomposition reaction is the only mechanism taking place in this synthesis.

By way of another example, the reaction of silver oxide and vanadium oxide is a typical combination reaction for the preparation of silver vanadium oxide. This combination reaction is illustrated below in equation 2.

½Ag₂O+V₂O₅→AgV₂O_{5.5} (2)

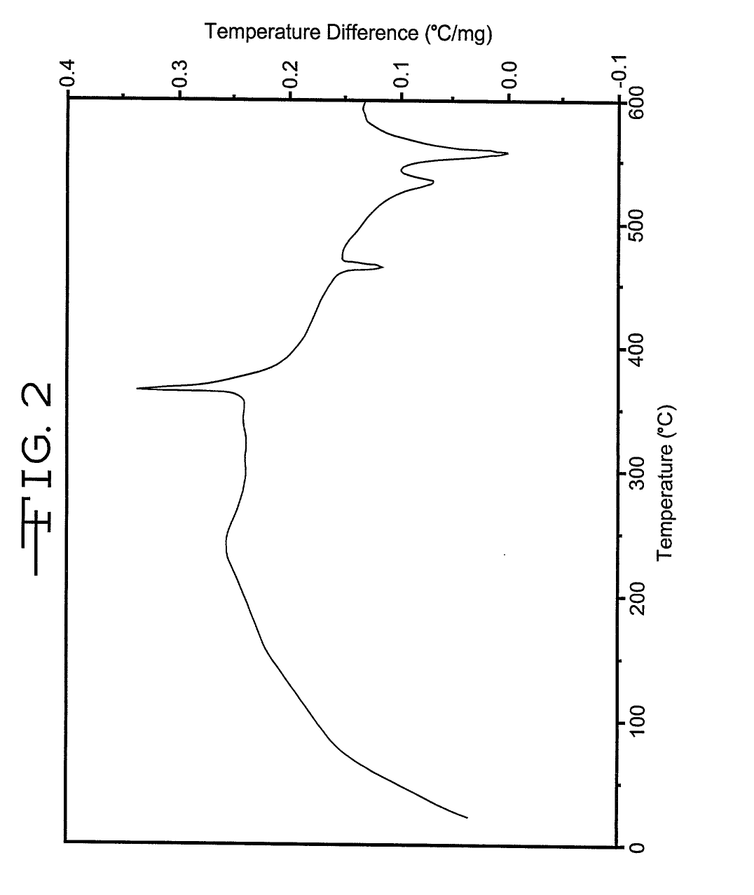

The thermal analysis of this combination reaction is shown in FIG. 2. In this figure, the exothermic transition at about 373° C. is assigned to the reaction of silver oxide with vanadium oxide. It should be noted that endothermic transitions due to decomposition of the silver starting material are absent in this thermal analysis.

In contrast to the prior art synthesis examples described in equations 1 and 2 above, silver vanadium oxide according to the present invention is prepared utilizing a chemical mechanism of sequential decomposition and combination reactions, in situ. Suitable decomposable starting materials include silver carbonate (Ag₂CO₃), silver acetate [Ag(CH₃CO₂)] and silver acetylacetonate [(AgCH₃COCH═C(O—)CH₃].

According to the present invention, any one of the decomposable starting materials is provided in a mixture with a metal, a metal oxide or a mixed metal oxide comprising at least a first and a second metals or their oxides and possibly a third metal or metal oxide, or a mixture of a first and a second metals or their metal oxides incorporated in the matrix of a host metal oxide. The cathode active material may also comprise a metal sulfide. The mixture is ground to ensure homogeneity and subsequently subjected to sequential decomposition and combination reactions to provide the novel mixed metal oxide cathode active material of the present invention. Thus, the present synthesis protocol occurs in an oxygen-containing atmosphere at a decomposition heating temperature depending on the decomposable starting material constituent. The exact temperature at which decomposition begins is dictated by the starting materials.

An example of this mechanism is the preparation of SVO from silver carbonate and vanadium oxide as illustrated below in equations 3 and 4.

½Ag₂CO₃+V₂O₅→½Ag₂O+½CO₂+V₂O₅ (3)

½Ag₂O+V₂O₅→AgV₂O_{5.5} (4)

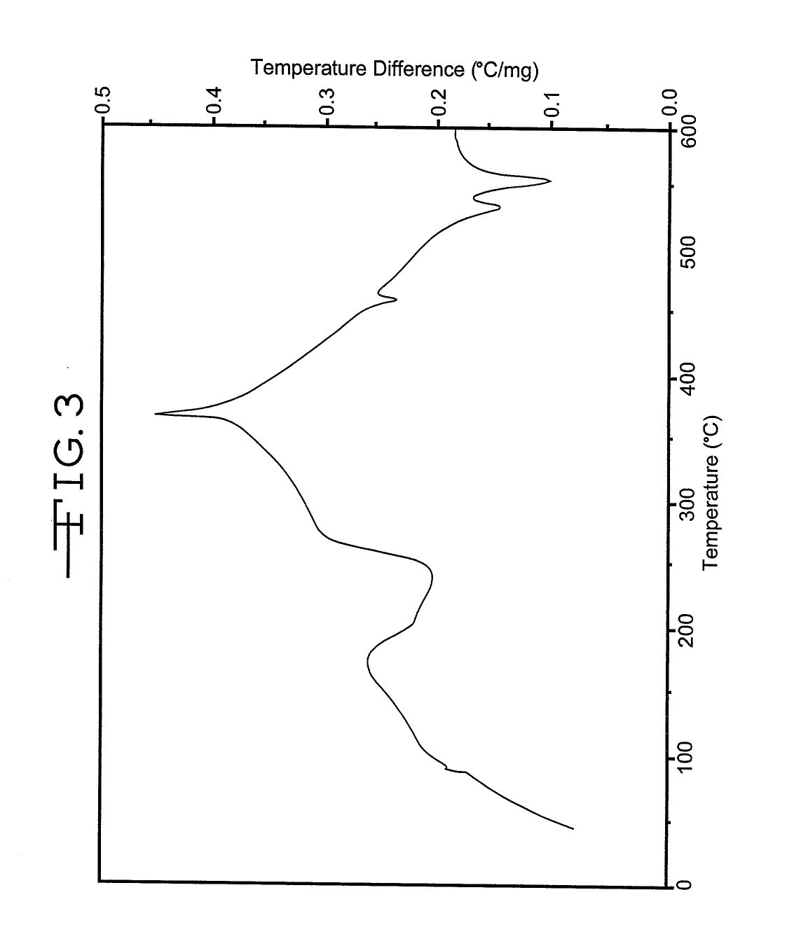

Equation 3 illustrates the decomposition of silver carbonate to give silver oxide and carbon dioxide. The thermal analysis of this mixture is shown in FIG. 3. In this figure, the endothermic transition at about 243° C. is assigned to the decomposition of silver carbonate. Likewise, in FIG. 3 the exotherm at about 373° C. is assigned to the combination reaction (equation 4) of silver oxide and vanadium oxide. The silver oxide in this mechanism was produced in situ by the decomposition reaction.

Table 1 indicates the temperatures appropriate for the decomposition heating reaction using different silver precursor materials according to the present invention. The maximum temperature is typically 275° C. to 500° C. above the temperature at which decomposition begins. However, this temperature range should not be viewed as limiting the present invention. It is merely a recommended temperature range.

TABLE 1

| Silver Precursor | Decomposition Begins |
|---|---|
| Ag₂CO₃ | 218° C. |
| Ag(CH₃CO₂) | 225° C. |
| AgCH₃COCH═C(O—)CH₃ | 100° C. |

By way of illustration, and in no way intended to be limiting, one exemplary cathode active material substantially comprises silver vanadium oxide (SVO) having the general formula AgₓV₂O_{y} in any one of its phases, i.e., β-phase silver vanadium oxide having in the general formula x=0.35 and y=5.18, γ-phase silver vanadium oxide having in the general formula x=0.80 and y=5.40 and ε-phase silver vanadium oxide having in the general formula x=1.0 and y=5.5, the latter phase being most preferred.

The preparation technique of a mixed metal oxide according to the present invention produces an active material displaying increased capacity and decreased voltage delay in comparison to a mixed metal oxide, such as silver vanadium oxide, prepared by a decomposition synthesis from AgNO₃ and V₂O₅ starting materials according to the previously referenced U.S. patents to Liang et al. and Keister et al., and the publications to Takeuchi et al. and Leising et al. The discharge capacity and decreased voltage delay of the mixed metal oxide of the present invention is also an improvement over that of silver vanadium oxide typically prepared from Ag₂O and V₂O₅ by a chemical addition reaction, such as is described in the previously referenced U.S. patents to Takeuchi et al. and Crespi.

Advantages of the use of this new cathode active material include increased capacity and decreased voltage delay for pulse discharge applications. An example of such an application is the implantable cardiac defibrillator, where the battery may run under a light load for extended periods of time interrupted by high rate pulse discharge. The occurrence of voltage delay under these conditions is detrimental in that it may shorten device life.

The above described active materials are formed into an electrode for incorporation into an electrochemical cell by mixing one or more of them with a conductive additive such as acetylene black, carbon black and/or graphite. Metallic materials such as nickel, aluminum, titanium and stainless steel in powder form are also useful as conductive diluents when mixed with the above listed active materials. The electrode further comprises a binder material which is preferably a fluoro-resin powder such as powdered polytetrafluoroethylene (PTFE) or powdered polyvinylidene fluoride (PVDF). More specifically, a preferred cathode active material comprises SVO in any one of its many phases, or mixtures thereof, mixed with a binder material and a conductive diluent.

A preferred cathode active admixture according to the present invention comprises from about 80% to 99%, by weight, of a cathode active material comprising SVO mixed with a suitable binder and a conductor diluent. The resulting blended cathode active mixture may be formed into a free-standing sheet prior to being contacted with a current collector to form the cathode electrode. The manner in which the cathode active mixture is prepared into a free-standing sheet is thoroughly described in U.S. Pat. No. 5,435,874 to Takeuchi et al., which is assigned to the assignee of the present invention and incorporated herein by reference. Further, cathode components for incorporation into the cell may also be prepared by rolling, spreading or pressing the cathode active mixture of the present invention onto a suitable current collector. Cathodes prepared as described above may be in the form of one or more plates operatively associated with at least one or more plates of anode material, or in the form of a strip wound with a corresponding strip of anode material in a structure similar to a “jellyroll”.

In order to prevent internal short circuit conditions, the cathode is separated from the anode material by a suitable separator material. The separator is of electrically insulative material, and the separator material also is chemically unreactive with the anode and cathode active materials and both chemically unreactive with and insoluble in the electrolyte. In addition, the separator material has a degree of porosity sufficient to allow flow there through of the electrolyte during the electrochemical reaction of the cell. Illustrative separator materials include fabrics woven from fluoropolymeric fibers including polyvinylidine fluoride, polyethylene tetrafluoroethylene, and polyethylenechlorotrifluoroethylene used either alone or laminated with a fluoropolymeric microporous film, non-woven glass, polypropylene, polyethylene, glass fiber materials, ceramics, a polytetrafluoroethylene membrane commercially available under the designation ZITEX (Chemplast Inc.), a polypropylene membrane commercially available under the designation CELGARD (Celanese Plastic Company, Inc.) and a membrane commercially available under the designation DEXIGLAS (C. H. Dexter, Div., Dexter Corp.). The separator may also be composed of non-woven glass, glass fiber materials and ceramic materials.

The form of the separator typically is a sheet which is placed between the anode and cathode electrodes and in a manner preventing physical contact there between. Such is the case when the anode is folded in a serpentine-like structure with a plurality of cathode plates disposed intermediate the anode folds and received in a cell casing or when the electrode combination is rolled or otherwise formed into a cylindrical “jellyroll” configuration.

The electrochemical cell of the present invention further includes a nonaqueous, ionically conductive electrolyte operatively associated with the anode and the cathode electrodes. The electrolyte serves as a medium for migration of ions between the anode and the cathode during the electrochemical reactions of the cell, and nonaqueous solvents suitable for the present invention are chosen so as to exhibit those physical properties necessary for ionic transport (low viscosity, low surface tension and wettability). Suitable nonaqueous solvents are comprised of an inorganic salt dissolved in a nonaqueous solvent and more preferably an alkali metal salt dissolved in a mixture of aprotic organic solvents comprising a low viscosity solvent including organic esters, ethers and dialkyl carbonates, and mixtures thereof, and a high permittivity solvent including cyclic carbonates, cyclic esters and cyclic amides, and mixtures thereof. Low viscosity solvents include tetrahydrofuran (THF), diisopropylether, methyl acetate (MA), diglyme, triglyme, tetraglyme, 1,2-dimethoxyethane (DME), 1,2-diethoxyethane (DEE), 1-ethoxy,2-methoxyethane (EME), dimethyl carbonate (DMC), diethyl carbonate (DEC), dipropyl carbonate (DPC), ethylmethyl carbonate (EMC), methylpropyl carbonate (MPC), ethylpropyl carbonate (EPC), and mixtures thereof. High permittivity solvents include propylene carbonate (PC), ethylene carbonate (EC), butylene carbonate (BC), acetonitrile, dimethyl sulfoxide, dimethyl formamide, dimethyl acetamide, γ-valerolactone, γ-butyrolactone (GBL), N-methyl-pyrrolidinone (NMP), and mixtures thereof.

The preferred electrolyte comprises an inorganic alkali metal salt, and in the case of an anode comprising lithium, the alkali metal salt of the electrolyte is a lithium based salt. Known lithium salts that are useful as a vehicle for transport of alkali metal ions from the anode to the cathode include LiPF₆, LiBF₄, LiAsF₆, LiSbF₆, LiClO₄, LiAlCl₄, LiGaCl₄, LiC(SO₂CF₃)₃, LiN(SO₂CF₃)₂, LiSCN, LiO₃SCF₂CF₃, LiC₆F₅SO₃, LiO₂CCF₃, LiSO₃F, LiNO₃, LiO₂, LiB(C₆H₅)₄, LiCF₃SO₃, and mixtures thereof. Suitable salt concentrations typically range between about 0.8 to 1.5 molar.

In the present invention, the preferred electrochemical cell has an anode of lithium metal and a cathode of the transition mixed metal oxide AgV₂O_{5.5} prepared by sequential decomposition and combination reactions, as previously described in detail. The activating electrolyte is 1.0M to 1.4M LiAsF₆ dissolved in an aprotic solvent mixture comprising at least one of the above listed low viscosity solvents and at least one of the above listed high permittivity solvents having an organic carbonate additive provided therein. The preferred aprotic solvent mixture comprises a 50/50 mixture, by volume, of propylene carbonate and dimethoxyethane.

The assembly of the cell described herein is preferably in the form of a wound element cell. That is, the fabricated cathode, anode and separator are wound together in a “jellyroll” type configuration or “wound element cell stack” such that the anode is on the outside of the roll to make electrical contact with the cell case in a case-negative configuration. Using suitable top and bottom insulators, the wound cell stack is inserted into a metallic case of a suitable size dimension. The metallic case may comprise materials such as stainless steel, mild steel, nickel-plated mild steel, titanium, tantalum or aluminum, but not limited thereto, so long as the metallic material is compatible for use with components of the cell.

The cell header comprises a metallic disc-shaped body with a first hole to accommodate a glass-to-metal seal/terminal pin feedthrough and a second hole for electrolyte filling. The glass used is of a corrosion resistant type having up to about 50% by weight silicon such as CABAL 12, TA 23 or FUSITE 425 or FUSITE 435. The positive terminal pin feedthrough preferably comprises titanium although molybdenum, aluminum, nickel alloy, or stainless steel can also be used. The cell header comprises elements having compatibility with the other components of the electrochemical cell and is resistant to corrosion. The cathode lead is welded to the positive terminal pin in the glass-to-metal seal and the header is welded to the case containing the electrode stack. The cell is thereafter filled with the electrolyte solution comprising at least one of the carbonate additives described hereinabove and hermetically sealed such as by close-welding a stainless steel ball over the fill hole, but not limited thereto.

The above assembly describes a case-negative cell, which is the preferred construction of the exemplary cell of the present invention. As is well known to those skilled in the art, the exemplary electrochemical system of the present invention can also be constructed in a case-positive configuration.

The following examples describes the manner and process of an electrochemical cell according to the present invention, and they set forth the best mode contemplated by the inventors for carrying out the invention, but they are not to be construed as limiting.

### EXAMPLE I

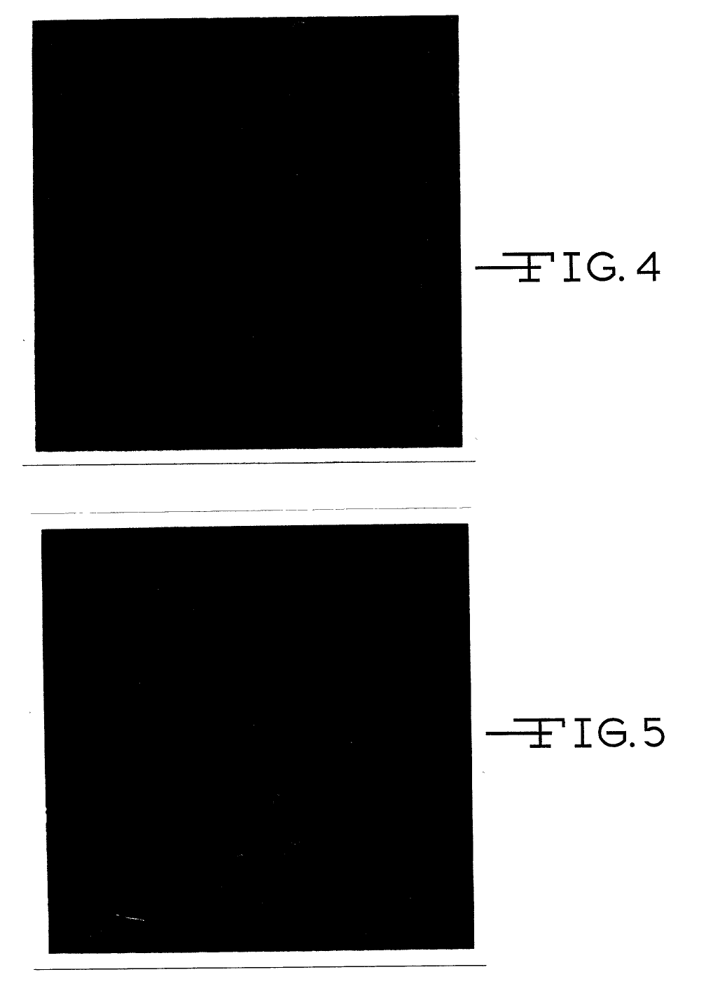

SVO materials were prepared by the three mechanisms described above. D-SVO was prepared using a 1:1 ratio of silver nitrate and vanadium oxide, C-SVO was prepared using a 1:2 ratio of silver oxide and vanadium oxide, and DC-SVO was prepared using a 1:2 ratio of silver carbonate and vanadium oxide. The ratio of silver starting materials to vanadium oxide was chosen in each of these preparations to give a constant Ag/V ratio of 1:2 in the final SVO product. All three preparations involved mixing the starting materials and heating the samples to 500° C. under an air atmosphere. After about 16 hours of heating, the samples were cooled, mixed again and reheated to 500° C. for about 32 hours. SEM micrographs were obtained for the final SVO products and are displayed in FIGS. 4 to 9.

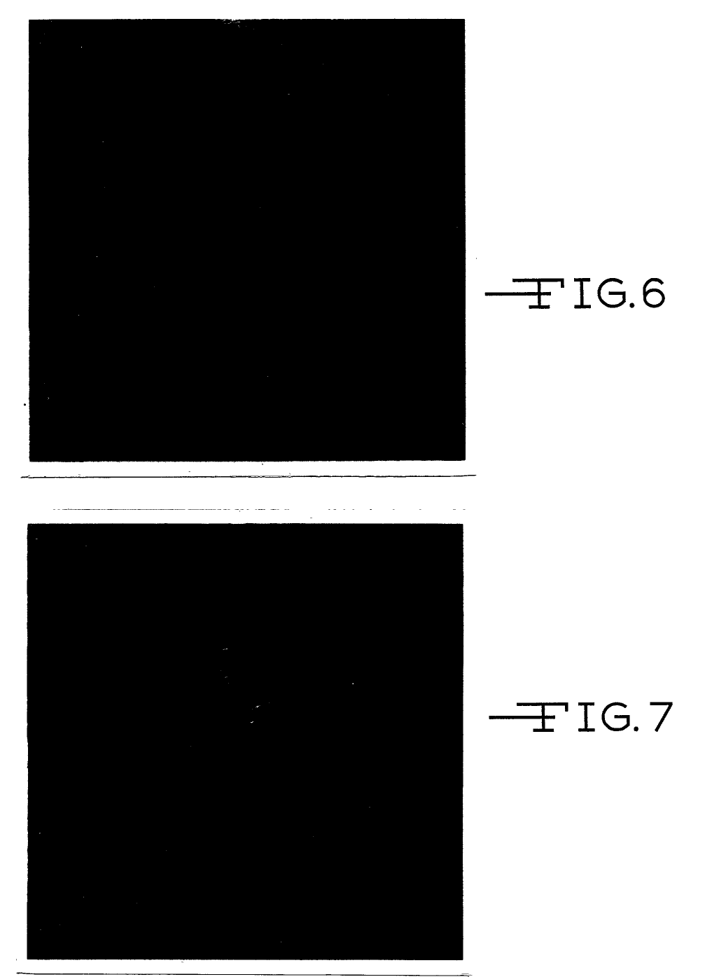

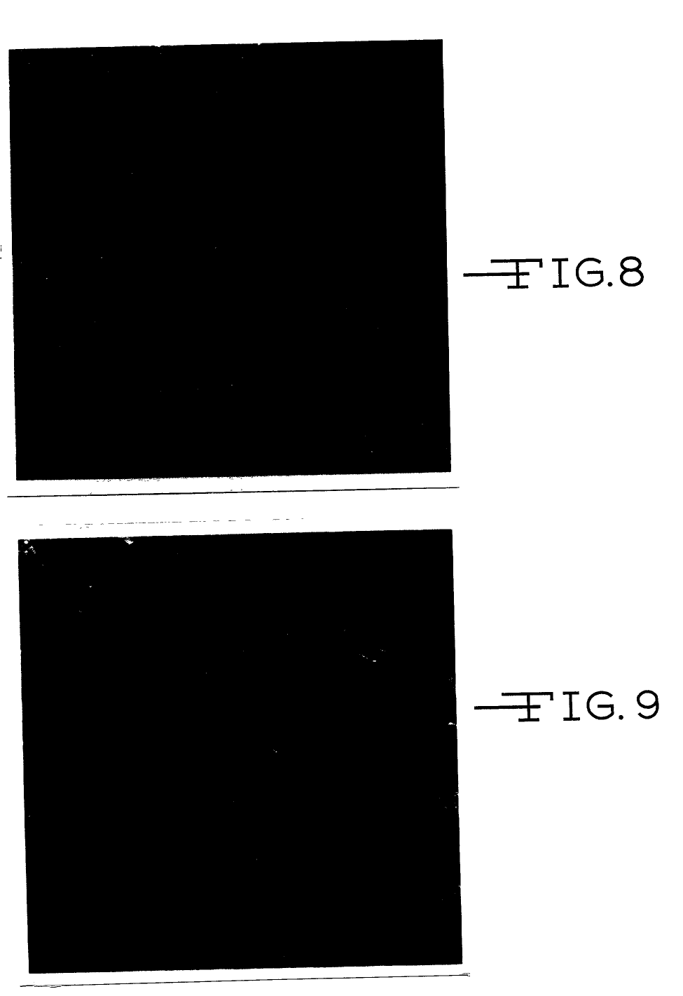

In FIGS. 4 and 5, the respective 100× and 1000× magnifications of the prior art D-SVO material prepared from silver nitrate and vanadium oxide are illustrated. Differences can be seen in these micrographs when compared to those in FIGS. 6 and 7 for the respective 100× and 1,000× photographs of prior art C-SVO prepared from silver oxide and vanadium oxide. In particular, the agglomerates of particles in C-SVO are more compact than the agglomerates of particles in D-SVO. This result is attributed to the different nature of the mechanisms. In the decomposition mechanism, NOₓ gas is released during the reaction creating disorder on a nano scale, and resulting in less order in the agglomerates of particles than seen for C-SVO. Interestingly, the SEM micrographs of DC-SVO prepared from silver carbonate and vanadium oxide according to the present invention and presented in FIGS. 8 and 9 show that DC-SVO has similarities to both the D-SVO and C-SVO samples. At a low magnification of 100× (FIG. 8) the agglomerates of particles of DC-SVO resemble those found for D-SVO. This is likely a result of the decomposition step inherent in both mechanisms. At high magnification of 1000× (FIG. 9), however, the individual DC-SVO particles more resemble those seen for C-SVO, indicating that the combination mechanism occurring for both DC-SVO and C-SVO has a similar influence on the individual particle size and morphology.

### EXAMPLE II

The performance of Li/SVO cells was tested using DC-SVO of the present invention in comparison to prior art D-SVO. In particular, hermetically-sealed electrochemical cells were constructed having cathodes consisting of a mixture of 94% of SVO (by weight) along with 3% Teflon 7A®, 2% graphite, and 1% carbon black. This active mixture was pressed onto an expanded titanium current collector. A total of 7.9 grams of cathode mix was utilized in each cell. The cathodes were separated from the lithium anode by a polypropylene separator. Lithium metal in contact with an expanded nickel current collector was placed against the separator facing the cathode. The cells were filled with 1M LiAsF₆ in PC/DME (1:1) electrolyte.

The cells were subjected to constant current pulses of 2.0 Amps for 10 sec in duration. The current pulses were applied in groups of four every 30 minutes at 37° C. This rapid discharge lasted about 3 days. The pulse testing results are listed in Table 2.

TABLE 2
Pulse Discharge of Experimental Li/SVO Cells

| | Capacity (mAh) | | |
|---|---|---|---|
| | to: | | |
| SVO Type | +2.0 V | +1.7 V | +1.5 V |
| DC-SVO | 1615 | 1730 | 1778 |
| D-SVO | 1548 | 1723 | 1787 |

As can be seen in Table 2, the capacity of the cells on short term discharge is very similar. On average, the cells utilizing DC-SVO give slightly higher capacity when discharge is stopped at a +2.0V cutoff. At +1.7V and +1.5V cutoffs, the delivered capacity of the cells were virtually identical.

### EXAMPLE III

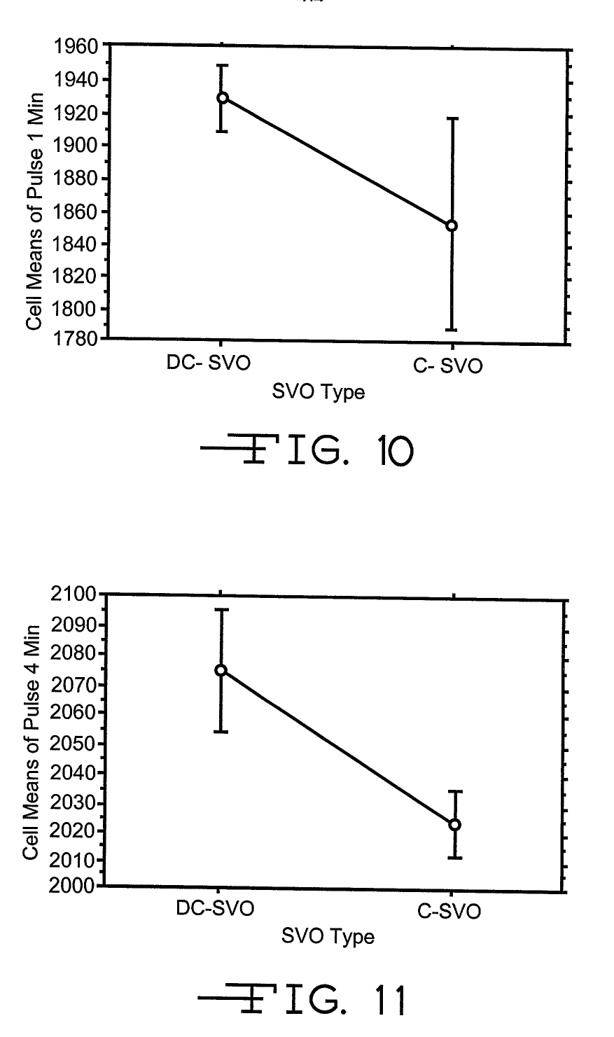

Li/SVO cells identical to those described in Example II were constructed and placed on long term test. These cells were subjected to constant current pulses of 2.0 Amps for 10 seconds in duration as before, but the length of time between groups of 4 pulses was extended to 2 months. In addition, the cells were placed on a 17.4 kΩ background load during storage time between pulse trains. The longer duration of this test better represents the type of use the cells will experience in a biomedical device. Five cells utilizing DC-SVO cathodes and five cells with D-SVO cathodes were placed on test at 37° C. The results of the pulse discharge at about 46% and 55% depth of discharge (DOD) are given in Table 3. Average pulse 1 minima (P1min) and pulse 4 minima (P4min) values at 55% depth of discharge (DOD) are plotted with 95% confidence limits in FIGS. 10 and 11, respectively.

TABLE 3
Pulse Discharge of Experimental Li/SVO Cells
On Long Term Test

| | | Capacity (mAh) | | |
|---|---|---|---|---|
| | | Prepulse | Pulse 1 | Pulse 4 |
| SVO Type | DOD | (mV) | Min (mV) | Min (mV) |
| DC-SVO | 46% | 2602 | 1971 | 2183 |
| D-SVO | 46% | 2596 | 1962 | 2175 |
| DC-SVO | 55% | 2594 | 1929 | 2075 |
| D-SVO | 55% | 2564 | 1853 | 2022 |

As can be seen in Table 3, DC-SVO cells on long term discharge provide higher pulse minimum voltages than cells using D-SVO. These higher voltages represent an increase in the energy provided by the DC-SVO cells relative to the D-SVO cells. This in turn improves the operation of the device using these batteries. In addition, higher voltages result in higher capacity delivered by the cells, and longer run time for the device.

Thus, according to the present invention, the use of SVO prepared from sequential decomposition and combination reactions provides the benefits of increased pulse voltages and less voltage delay in comparison to SVO material prepared according to the prior art. Lower pulse voltages caused by voltage delay, even if only temporary, are undesirable since they can cause circuit failure in device applications, and effectively result in shorter cell life.

It is appreciated that various modifications to the present inventive concepts described herein may be apparent to those of ordinary skill in the art without disparting from the spirit and scope of the present invention as defined by the herein appended claims.

What is claimed is:

1. An electrochemical cell comprising an anode; a cathode; and an electrolyte operatively associated with the anode and the cathode, the improvement in the cell comprising:
the cathode comprising a mixed metal oxide characterized as having been produced by sequential decomposition and combination reactions of a mixture of a first decomposable metal-containing constituent and a second metal oxide constituent.

2. The electrochemical cell of claim 1 wherein the mixture of the first and second constituents is characterized as having been heated to a first temperature above a decomposition temperature of the decomposable metal-containing constituent, followed by cooling to below the decomposition temperature and then heated to a second temperature above the decomposition temperature.

3. The electrochemical cell of claim 2 wherein the first and second temperatures are substantially the same.

4. The electrochemical cell of claim 2 wherein the first and second temperatures are different.

5. The electrochemical cell of claim 2 wherein the first temperature is at least about 100° C.

6. The electrochemical cell of claim 2 wherein the first temperature is from about 275° C. to about 500° C.

7. The electrochemical cell of claim 2 wherein the second temperature is from about 275° C. to about 500° C.

8. The electrochemical cell of claim 1 wherein the mixed metal oxide is characterized as having been formed from vanadium pentoxide and a thermally decomposable salt of silver as the decomposable metal-containing constituent selected from the groups consisting of Ag₂CO₃, Ag(CH₃CO₂), AgCH₃COCH—C(O—)CH₃, and mixtures thereof.

9. The electrochemical cell of claim 1 wherein the mixed metal oxide is characterized as having been formed by the sequential decomposition and combination reactions carried out in an atmosphere selected from the group consisting of air and oxygen.

10. The electrochemical cell of claim 1 wherein the mixed metal oxide is silver vanadium oxide.

11. The electrochemical cell of claim 2 wherein the mixture is characterized as having been ground between being heated to the first temperature and being heated to the second temperature.

12. The electrochemical cell of claim 1 wherein the anode is of an alkali metal, the electrolyte is a nonaqueous electrolyte and there is dissolved therein a Group IA metal salt.

13. An electrochemical cell, which comprises:
a) an anode comprising an alkali metal;
b) a cathode comprising silver vanadium oxide characterized as having been produced by sequential decomposition and combination reactions of a first salt of silver as a first decomposable metal-containing constituent and a second metal oxide constituent, wherein a mixture of the first and second constituents is heated to a first temperature above a decomposition temperature of the decomposable metal containing constituent, followed by cooling to below the decomposition temperature and then heated to a second temperature above the decomposition temperature; and
c) a nonaqueous electrolyte operatively associated with the anode and the cathode.

14. The electrochemical cell of claim 13 wherein the first temperature is from about 275° C. to about 500° C.

15. The electrochemical cell of claim 13 wherein the second temperature is from about 275° C. to about 500° C.

16. The electrochemical cell of claim 13 wherein the mixture is characterized as having been grounded between being heated to the first temperature and being heated to the second temperature.

17. The electrochemical cell of claim 13 wherein the nonaqueous electrolyte comprises a low viscosity solvent selected from the group consisting of an ester, an ether, a dialkyl carbonate, and mixtures thereof.

18. The electrochemical cell of claim 17 wherein the low viscosity solvent is selected from the group consisting of diisopropylether, 1,2-dimethoxyethane, 1,2-diethoxyethane, 1-ethoxy,2-methoxyethane, dimethyl carbonate, diethyl carbonate, dipropyl carbonate, ethylmethyl carbonate, methylpropyl carbonate, ethylpropyl carbonate, methyl acetate, tetrahydrofuran, diglyme, triglyme, tetraglyme, and mixtures thereof.

19. The electrochemical cell of claim 13 wherein the nonaqueous solvent comprises a high permittivity solvent selected from the group consisting of a cyclic carbonate, a cyclic ester, a cyclic amide, and mixtures thereof.

20. The electrochemical cell of claim 19 wherein the high permittivity solvent is selected from the group consisting of propylene carbonate, ethylene carbonate, butylene carbonate, γ-valerolactone, γ-butyrolactone, N-methyl-pyrrolidinone, dimethyl sulfoxide, acetonitrile, dimethyl formamide, dimethyl acetamide, and mixtures thereof.

21. The electrochemical cell of claim 13 wherein the electrolyte is selected from the group consisting of LiPF₆, LiAsF₆, LiSbF₆, LiBF₄, LiClO₄, LiAlCl₄, LiGaCl₄, LiC(SO₂CF₃)₃, LiN(SO₂CF₃)₂, LiSCN, LiO₃SCF₂CF₃, LiC₆F₅SO₃, LiO₂CCF₃, LiSO₃F, LiNO₃, LiB(C₆H₅)₄, LiCF₃SO₃, and mixtures thereof.

22. The electrochemical cell of claim 13 wherein the silver vanadium oxide is substantially of the general formula AgₓV₂O_{y} selected from one of an ε-phase with x=1.0 and y=5.5, γ-phase with x=0.80 and y=5.40, β-phase with x=0.35 and y=5.18, and mixtures thereof.

23. The electrochemical cell of claim 13 wherein the silver vanadium oxide is characterized as having been formed from the first decomposable metal-containing constituent selected from the group consisting of Ag₂CO₃, Ag(CH₃CO₂), AgCH₃COCH—C(O═)CH₃, and mixtures thereof.

24. The electrochemical cell of claim 13 wherein the first and second temperatures are the same or different.

25. The electrochemical cell of claim 13 wherein the cathode comprises from between about 80 weight percent to about 99 weight percent of the silver vanadium oxide.

26. The electrochemical cell of claim 13 wherein the cathode further comprises a conductive additive.

27. The electrochemical cell of claim 13 wherein the cathode further comprises a binder material.

28. The electrochemical cell of claim 13 wherein the electrolyte comprises a solution of a Group IA metal salt dissolved in a nonaqueous solvent.

29. The electrochemical cell of claim 13 wherein the anode is lithium.

30. A method for reducing the voltage delay in an electrochemical cell, comprising the steps of:
a) providing an anode;
b) providing a cathode comprising a mixed metal oxide produced by sequential decomposition and combination reactions from a first salt of silver as a decomposable metal-containing constituent and a second metal oxide constituent, wherein a mixture of the first and second constituents is heated to a first temperature above a decomposition temperature of the decomposable metal-containing constituent, followed by cooling to below the decomposition temperature and then heating to a second temperature above the decomposition temperature; and
c) activating the electrochemical cell with the electrolyte operatively associated with the anode and the cathode.

31. The method of claim 30 including providing the mixed metal oxide as silver vanadium oxide.

32. The method of claim 30 including providing the first and second temperatures being the same or different.

33. The method of claim 30 wherein the first temperature is from about 275° C. to about 500° C.

34. The method of claim 30 wherein the second temperature is from about 275° C. to about 500° C.

35. The method of claim 30 wherein the mixed metal oxide is characterized as having been formed from vanadium pentoxide and a salt of silver as the decomposable metal-containing constituent selected from the group consisting of Ag₂CO₃, Ag(CH₃CO₂), AgCH₃COCH═C(O—)CH₃, and mixtures thereof.

36. The method of claim 30 including providing the anode as comprising lithium.

37. The method of claim 30 including providing the nonaqueous electrolyte comprising a low viscosity solvent and selecting the low viscosity solvent from the group consisting of an ester, an ether, a dialkyl carbonate, and mixtures thereof.

38. The method of claim 30 including providing the nonaqueous electrolyte comprising a high permittivity solvent and selecting the high permittivity solvent from the group consisting of a cyclic carbonate, a cyclic ester, a cyclic amide, and mixtures thereof.
